(19) United States
(12) Patent Application Publication
(10) Pub. No.: US 2009/0319341 A1
(43) Pub. Date: Dec. 24, 2009

(54) METHODS AND SYSTEMS FOR OBTAINING VEHICLE ENTERTAINMENT STATISTICS

(76) Inventors: Eric C. Berkobin, Woodstock, GA (US); Jeffrey Leddy, Duluth, GA (US)

Correspondence Address: HUGHES TELEMATICS, INC., 41 PERIMETER CENTER EAST, SUITE 400, ATLANTA, GA, 30346, US

(21) Appl. No.: 12/486,134

(22) Filed: Jun. 17, 2009

Related U.S. Application Data
(60) Provisional application No. 61/073,898, filed on Jun. 19, 2008.

(51) Int. Cl. G06Q 30/00; G06Q 10/00; G06Q 50/00

(52) U.S. Cl. 705/10; 705/14.62; 705/14.45

(57) ABSTRACT

A telematics control unit in a vehicle couples to a vehicle communication network bus and monitors signals on the bus that correspond to various parameters related to entertainment devices in the vehicle, such as, for examples, a radio, a telephone, and a video player. During a predetermined period, the TCU monitors the entertainment device signals and stores information represented by the signals to a memory. The TCU transmits the entertainment device signal information from the memory to a telematics operations center server operated by a telematics services provider. The TOC is configured to analyze the status of the entertainment signal information to determine various entertainment device settings in the vehicle and how they correlate with given entertainment programming, based on programs being broadcast when the TCU monitors the signal, or programs an occupant of the vehicle plays from storage media. Advertisers may obtain the information analysis and tailor advertising accordingly.

### CROSS REFERENCE TO RELATED APPLICATION

This application claims priority under 35 U.S.C. sec. 119 to provisional patent application 61/073,898, filed Jun. 19, 2008, entitled “Methods and systems for obtaining vehicle entertainment statistics,” which the present application herein incorporates by reference in its entirety.

### TECHNICAL FIELD

The invention relates to using a telematics control unit to gather and transmit information related to the operation of entertainment devices in a vehicle, and more particularly to monitoring signals on a vehicle's communication bus and transmitting the information contained in the signals to a central server that analyzes the information to determine a user entertainment device profile.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 illustrates a block diagram of vehicle telematics unit.

FIG. 2 illustrates a schematic diagram of a network environment.

FIG. 3 illustrates a block diagram of a TCU operating environment.

FIG. 4 illustrates a flow diagram of a TCU providing entertainment statistic information.

FIG. 5 illustrates a flow diagram of a TCU processor coupled to a vehicle bus and a wireless transceiver.

FIG. 6 illustrates a system diagram of a TCU and TOC server coupled to a communication network.

FIG. 7 illustrates a flow diagram for tailoring advertising to a driver's entertainment usage behavior.

### DETAILED DESCRIPTION

Before the present methods and systems are disclosed and described, it is to be understood that the methods and systems are not limited to specific synthetic methods, specific components, or to particular compositions, as such may, of course, vary. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the Examples included therein and to the Figures and their previous and following description.

In an embodiment of the present system, a service provider organization can provide and allow access, for example on a subscriber fee or pay-per-use basis, to a tool that obtains, monitors, records and reports vehicle entertainment statistics via a network, wirelessly or wired, such as the Internet. That is, the service provider can provide the hardware (e.g., servers) and software (e.g., database) infrastructure, application software, customer support, and billing mechanism to allow its customers (e.g., satellite radio providers, corporate advertisers, advertising agencies and the like) to receive reports of, for example, listener reaction to specific events or segments. This tool can be used by subscribers to obtain both real-time and historical information, characteristics, and trend analysis to make marketing and advertising decisions.

The level of detail collected by the present vehicle entertainment statistics system, provides the ability to accurately measure the popularity of new marketing campaigns, radio personalities, television shows, DVD's, songs, or any other vehicle entertainment. For example, advertisers can determine how many listeners heard their advertisements, how many turned the station seconds into the advertisements, and how many turned the volume up to hear a segment. Radio stations (both terrestrial and satellite) can determine listener reactions to new talents and segments identifying events that cause listeners to migrate to competitors. In each case, the reported statistics provide the ability to adjust and refine entertainment content contributing to its overall effectiveness and value by reducing listener churn.

In an embodiment of the present vehicle entertainment statistics system the service provider can provide a World Wide Web site where a subscriber, using a computer and Web browser software, can remotely view and receive comprehensive vehicle entertainment statistics.

In an alternative embodiment, the tool that obtains, monitors, records and reports comprehensive vehicle entertainment statistics may reside, instead of on the global Internet, locally on proprietary equipment owned by a subscriber (i.e., radio providers, corporate advertisers, advertising agencies and the like) as a stand alone system software application.

The terms “user,” “subscriber,” “customer,” “company,” “business concern,” “radio provider,” “corporate advertiser,” “advertising agency,” and the plural forms of these terms are used interchangeable throughout herein to refer to those who would access, use, and/or benefit from the disclosed system for obtaining, monitoring, recording and reporting comprehensive vehicle entertainment statistics.

One aspect provides an apparatus comprising a telematics unit. The apparatus can be installed in a vehicle. Such vehicles include, but are not limited to, personal and commercial automobiles, motorcycles, transport vehicles, watercraft, aircraft, and the like. For example, an entire fleet of a vehicle manufacturer's vehicles can be equipped with the apparatus. The apparatus 101 is also referred to herein as a vehicle telematics unit (“VTU”), or a telematics control unit (“TCU”) 101. Apparatus 101 can perform any of the methods disclosed herein in part and/or in their entireties.

In an aspect, all components of the telematics unit 101 can be contained within a single box and controlled with a single core processing subsystem. In another aspect, the components can be distributed throughout a vehicle. Each of the components of the apparatus can be separate subsystems of the vehicle, for example, a communications component such as a SDARS, or other satellite receiver, can be coupled with an entertainment system of the vehicle.

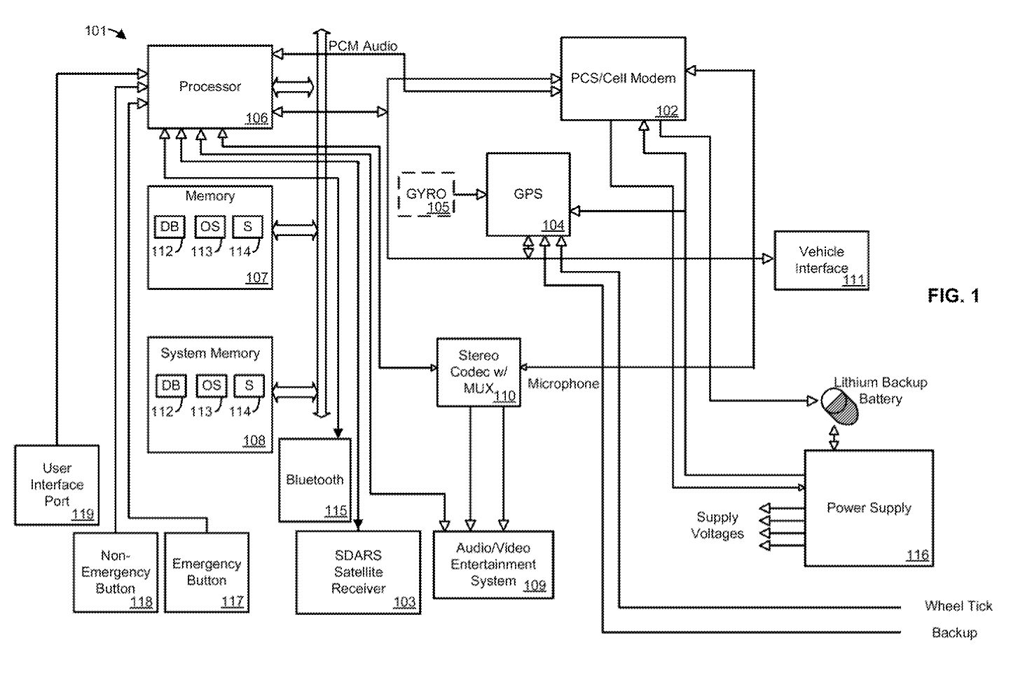

An exemplary apparatus 101 is illustrated in FIG. 1. This exemplary apparatus is only an example of an apparatus and is not intended to suggest any limitation as to the scope of use or functionality of operating architecture. Neither should the apparatus be necessarily interpreted as having any dependency or requirement relating to any one or combination of components illustrated in the exemplary apparatus. The apparatus 101 can comprise one or more communications components. Apparatus 101 illustrates communications components (modules) PCS/Cell Modem 102 and SDARS receiver 103. These components can be referred to as vehicle mounted transceivers when located in a vehicle. PCS/Cell Modem 102 can operate on any frequency available in the country of operation, including, but not limited to, the 850/1900 MHz cellular and PCS frequency allocations. The type of communications can include, but is not limited to GPRS, EDGE, UMTS, 1×RTT or EV-DO. The PCS/Cell Modem 102 can be a Wi-Fi or mobile Worldwide Interoperability for Microwave Access (WIMAX) implementation that can support operation on both licensed and unlicensed wireless frequencies. The apparatus 101 can comprise an SDARS receiver 103 or other satellite receiver. SDARS receiver 103 can utilize high powered satellites operating at, for example, 2.35 GHz to broadcast digital content to automobiles and some terrestrial receivers, generally demodulated for audio content, but can contain digital data streams.

PCS/Cell Modem 102 and SDARS receiver 103 can be used to update an onboard database 112 contained within the apparatus 101. Updating can be requested by the apparatus 101, or updating, can occur automatically. For example, database updates can be performed using FM subcarrier, cellular data download, other satellite technologies, Wi-Fi and the like. SDARS data downloads can provide the most flexibility and lowest cost by pulling digital data from an existing receiver that exists for entertainment purposes. An SDARS data stream is not a channelized implementation (like AM or FM radio) but a broadband implementation that provides a single data stream that is separated into useful and applicable components.

GPS receiver 104 can receive position information from a constellation of satellites operated by the U.S. Department of Defense. Alternately, the GPS receiver 104 can be a GLONASS receiver operated by the Russian Federation Ministry of Defense, or any other positioning device capable of providing accurate location information (for example, LORAN, inertial navigation, and the like). GPS receiver 104 can contain additional logic, either software, hardware or both to receive the Wide Area Augmentation System (WAAS) signals, operated by the Federal Aviation Administration, to correct dithering errors and provide the most accurate location possible. Overall accuracy of the positioning equipment subsystem containing WAAS is generally in the two meter range. Optionally, the apparatus 101 can comprise a MEMS gyro 105 for measuring angular rates and wheel tick inputs for determining the exact position based on dead-reckoning techniques. This functionality is useful for determining accurate locations in metropolitan urban canyons, heavily tree-lined streets and tunnels.

In an aspect, the GPS receiver 104 can activate on ignition or start of motion. The GPS receiver 104 can go into idle on ignition off or after ten minutes without motion. Time to first fix can be <45s 90% of the time. For example, this can be achieved either through chipset selection or periodic wake-up.

One or more processors 106 can control the various components of the apparatus 101. Processor 106 can be coupled to removable/non-removable, volatile/non-volatile computer storage media. By way of example, FIG. 1 illustrates memory 107, coupled to the processor 106, which can provide non-volatile storage of computer code, computer readable instructions, data structures, program modules, and other data for the computer 101. For example and not meant to be limiting, memory 107 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like. Data obtained and/or determined by processor 106 can be displayed to a vehicle occupant and/or transmitted to a remote processing center. This transmission can occur over a wired or a wireless network. For example, the transmission can utilize PCS/Cell Modem 102 to transmit the data. The data can be routed through the Internet where it can be accessed, displayed and manipulated.

The processing of the disclosed systems and methods can be performed by software components. The disclosed system and method can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed method can also be practiced in grid-based and distributed computing environments where tasks are performed by remote processing devices that are linked through a communications network. In a distributed computing environment, program modules can be located in both local and remote computer storage media including memory storage devices.

The methods and systems can employ Artificial Intelligence techniques such as machine learning and iterative learning. Examples of such techniques include, but are not limited to, expert systems, case based reasoning, Bayesian networks, behavior based Al, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

Any number of program modules can be stored on the memory 107, including by way of example, an operating system 113 and software 114. Each of the operating system 113 and software 114 (or some combination thereof) can comprise elements of the programming and the software 114. Data can also be stored on the memory 107 in database 112. Database 112 can be any of one or more databases known in the art. Examples of such databases comprise, DB2®, Microsoft® Access, Microsoft® SQL Server, Oracle®, mySQL, PostgreSQL, and the like. The database 112 can be centralized or distributed across multiple systems. The software 114 can comprise telematics software and the data can comprise telematics data.

In some aspects, data can be stored and transmitted in loss-less compressed form and the data can be tamper-proof. Non-limiting examples of data that can be collected are as follows. After a connection is established the protocol being used can be stored. A timestamp can be recorded on ignition for one or more trips. Speed every second during the trip. Crash events can be stored (for example, as approximated via OBD II speed). By way of example, GPS related data that can be recorded during one or more trips can comprise one or more of, time, latitude, longitude, altitude, speed, heading, horizontal dilution of precision (HDOP), number of satellites locked, and the like. In one aspect, recorded data can be transmitted from the apparatus to a back-office for integrity verification and then via, for example, a cellular network. Once validated, data can be pushed to a company via established web-services & protocols.

By way of example, the operating system 113 can be a Linux (Unix-like) operating system. One feature of Linux is that it includes a set of “C” programming language functions referred to as, “NDBM”. NDBM is an API for maintaining key/content pairs in a database which allows for quick access to relatively static information. NDBM functions use a simple hashing function to allow a programmer to store keys and data in data tables and rapidly retrieve them based upon the assigned key. A major consideration for an NDBM database is that it only stores simple data elements (bytes) and requires unique keys to address each entry in the database. NDBM functions provide a solution that is among the fastest and most scalable for small processors.

It is recognized that such programs and components reside at various times in different storage components of the apparatus 101, and are executed by the processor 106 of the apparatus 101. An implementation of reporting software 114 can be stored on or transmitted across some form of computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any method or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

FIG. 1 illustrates system memory 108, coupled to the processor 106, which can comprise computer readable media in the form of volatile memory, such as random access memory (RAM, SDRAM, and the like), and/or non-volatile memory, such as read only memory (ROM). The system memory 108 typically contains data and/or program modules such as operating system 113 and software 114 that are immediately accessible to and/or are presently operated on by the processor 106. The operating system 113 can comprise a specialized task dispatcher, slicing available bandwidth among the necessary tasks at hand, including communications management, position determination and management, entertainment radio management, SDARS data demodulation and assessment, power control, and vehicle communications.

The processor 106 can control additional components within the apparatus 101 to allow for ease of integration into vehicle systems. The processor 106 can control power to the components within the apparatus 101, for example, shutting off GPS receiver 104 and SDARS receiver 103 when the vehicle is inactive, and alternately shutting off the PCS/Cell Modem 102 to conserve the vehicle battery when the vehicle is stationary for long periods of inactivity. The processor 106 can also control an audio/video entertainment subsystem 109 and comprise a stereo codec and multiplexer 110 for providing entertainment audio and video to the vehicle occupants, for providing wireless communications audio (PCS/Cell phone audio), speech recognition from the driver compartment for manipulating the SDARS receiver 103 and PCS/Cell Modem 102 phone dialing, and text to speech and pre-recorded audio for vehicle status annunciation.

The apparatus 101 can interface and monitor various vehicle systems and sensors to determine vehicle conditions. Apparatus 101 can interface with a vehicle through a vehicle interface 111. The vehicle interface 111 can include, but is not limited to, OBD (On Board Diagnostics) port, OBD-II port, CAN (Controller Area Network) port, and the like. A cable can be used to connect the vehicle interface 111 to a vehicle. Any type of cable capable of connecting to a vehicle diagnostics port can be used. In one aspect, an OBD II connector cable can be used that follows the J1962 trapezoidal connector specification, the J1939 or J1708 round connector specifications, and the like. A communication protocol such as, J1850 PWM, J1850 VPW, ISO9141-2, ISO14230-4, and the like can be used to collect data through the vehicle interface 111. For purposes of discussion, the vehicle interface 111 may be coupled to a bus, which facilitates the apparatus 101 in receiving data indicative of vehicle performance, such as vehicle trouble codes, operating temperatures, operating pressures, speed, fuel air mixtures, oil quality, oil and coolant temperatures, wiper and light usage, mileage, break pad conditions, and any data obtained from any discrete sensor that contributes to the operation of the vehicle engine and drive-train computer. Additionally CAN interfacing can eliminate individual dedicated inputs to determine brake usage, backup status, and it can allow reading of onboard sensors in certain vehicle stability control modules providing gyro outputs, steering wheel position, accelerometer forces and the like for determining driving characteristics.

The TCU can also acquire entertainment equipment parameter information from the vehicle bus via interface 111. The TCU can read signals present at the interface that represent information related to entertainment equipment parameter information. For example, signal representing information related to the volume, tone and station setting of the radio may be present at interface 111. Also, the artist and title of a music or video track being played in a player coupled to the bus may be available in a signal at interface 111. Signals present at interface 11 may also contain other information like use of a voice telephony device, information related to data transmitted and received via a wireless data link from and to the TCU 101 respectively. The apparatus 101 can interface directly with a vehicle subsystem or a sensor, such as an accelerometer, gyroscope, airbag deployment computer, and the like. Data obtained from, and processed data derived from, the various vehicle systems and sensors can be transmitted to a central monitoring station via the PCS/Cell Modem 102.

Communication with a vehicle driver can be through an infotainment (radio) head (not shown) or other display device (not shown). More than one display device can be used. Examples of display devices include, but are not limited to, a monitor, an LCD (Liquid Crystal Display), a projector, and the like. Audio/video entertainment subsystem 109 can comprise a radio receiver, FM, AM, Satellite, Digital and the like. Audio/video entertainment subsystem 109 can comprise one or more media players. An example of a media player includes, but is not limited to, audio cassettes, compact discs, DVD's, Blu-ray, HD-DVDs, Mini-Discs, flash memory, portable audio players, hard disks, game systems, and the like. Audio/video entertainment subsystem 109 can comprise a user interface for controlling various functions. The user interface can comprise buttons, dials, and/or switches. In certain embodiments, the user interface can comprise a display screen. The display screen can be a touch screen. The display screen can be used to provide information about the particular entertainment being delivered to an occupant, including, but not limited to Radio Data System (RDS) information, ID3 tag information, video, and various control functionality (such as next, previous, pause, etc. . . . ), websites, and the like. Audio/video entertainment subsystem 109 can utilize wired or wireless techniques to communicate to various consumer electronics including, but not limited to, cellular phones, laptops, PDAs, portable audio players (such as an iPod), and the like. Audio/video entertainment subsystem 109 can be controlled remotely through, for example, a wireless remote control, voice commands, and the like. In some aspects, processor 106 can provide media to the audio/video entertainment subsystem 109, for playback, display, etc. . . . .

In some aspects, processor 106 of TCU 101 can request and obtain information, and data, related to the entertainment choices made by vehicle occupants. In one aspect, the processor 106 can accomplish this through detecting and processing signals present on one or more vehicle communications buses. The processor 106 can be configured to obtain any available information related to the entertainment choices. Examples of these data include, but are not limited to, website information, channel selection, volume, song information (i.e., artist, title, album, genre, etc. . . . ), television show information (title, actors, genre, etc. . . . ), movie selection (title, actors, genre, etc. . . . ), present radio station setting, station preset information, time stamp and date stamp of radio station selection, global positioning system coordinates, radio status.

The processor 106 can determine various other data from the data received from the audio/video entertainment subsystem 109, such as vehicle entertainment information, and data. Examples include, but are not limited to, length of time an entertainment selection was experienced, volume and/or channel change correlated with entertainment selections, channel change correlated with time of day, channel change correlated with global positioning system coordinates, channel changes correlated with content of a vehicle entertainment data stream.

Data obtained and/or determined by processor 106 can be displayed to a vehicle occupant and/or transmitted to a remote processing center. This transmission can occur over a wired or a wireless network. For example, the transmission can utilize PCS/Cell Modem 102 to transmit the data. The data can be routed through the Internet where it can be accessed, displayed and manipulated.

The apparatus 101 can interface and monitor various vehicle systems and sensors to determine vehicle conditions. Apparatus 101 can interface with a vehicle through a vehicle interface 111. The vehicle interface 111 can include, but is not limited to, OBD (On Board Diagnostics) port, OBD-II port, CAN (Controller Area Network) port, and the like. The vehicle interface 111, allows the apparatus 101 to receive data indicative of vehicle performance, such as vehicle trouble codes, operating temperatures, operating pressures, speed, fuel air mixtures, oil quality, oil and coolant temperatures, wiper and light usage, mileage, break pad conditions, and any data obtained from any discrete sensor that contributes to the operation of the vehicle engine and drive-train computer. Additionally CAN interfacing can eliminate individual dedicated inputs to determine brake usage, backup status, and it can allow reading of onboard sensors in certain vehicle stability control modules providing gyro outputs, steering wheel position, accelerometer forces and the like for determining driving characteristics. The apparatus 101 can interface directly with a vehicle subsystem or a sensor, such as an accelerometer, gyroscope, airbag deployment computer, and the like. Data obtained, and processed data derived from, from the various vehicle systems and sensors can be transmitted to a central monitoring station via the PCS/Cell Modem 102.

The methods, systems, and apparatuses provided can utilize a power management scheme ensuring that a consumer's car battery is not impaired under normal operating conditions. This can include battery backup support when the vehicle is off in order to support various wake-up and keep-alive tasks. All data collected subsequent to the last acknowledged download can be maintained in non-volatile memory until the apparatus is reconnected to an external power source. At that point, the apparatus can self re-initialize and resume normal operation. Specific battery chemistry can optimize life/charge cycles. The battery can be rechargeable. The battery can be user replaceable or non-user replaceable.

The apparatus 101 can receive power from power supply 116. The power supply can have many unique features necessary for correct operation within the automotive environment. One mode is to supple a small amount of power (typically less than 100 microamps) to at least one master controller that can control all the other power buses inside of the VTU 101. In an exemplary system, a low power low dropout linear regulator supplies this power to PCS/Cellular modem 102. This provides the static power to maintain internal functions so that it can await external user push-button inputs or await CAN activity via vehicle interface 111. Upon receipt of an external stimulus via either a manual push button or CAN activity, the processor contained within the PCS/Cellular modem 102 can control the power supply 116 to activate other functions within the VTU 101, such as GPS 104/GYRO 105, Processor 106/Memory 107 and 108, SDARS receiver 103, audio/video entertainment system 109, audio codec mux 110, and any other peripheral within the VTU 101 that does not require standby power.

In an exemplary system, there can be a plurality of power supply states. One state can be a state of full power and operation, selected when the vehicle is operating. Another state can be a full power relying on battery backup. It can be desirable to turn off the GPS and any other non-communication related subsystem while operating oil the back-up batteries. Another state can be when the vehicle has been shut off recently, perhaps within the last 30 days, and the system maintains communications with a two-way wireless network for various auxiliary services like remote door unlocking and location determination messages. After the recent shut down period, it is desirable to conserve the vehicle battery by turning off almost all power except the absolute minimum in order to maintain system time of day clocks and other functions, waiting to be awakened on CAN activity. Additional power states are contemplated, such as a low power wakeup to check for network messages, but these are nonessential features to the operation of the VTU.

Normal operation can comprise, for example, the PCS/Cellular modem 102 waiting for an emergency push button, key-press, or CAN activity. Once either is detected, the PCS/Cellular modem 102 can awaken and enable the power supply 116 as required. Shutdown can be similar wherein a first level shutdown turns off everything except the PCS/Cellular modem 102, for example. The PCS/Cellular modem 102 can maintain wireless network contact during this state of operation. The VTU 101 can operate normally in the state when the vehicle is turned off. If the vehicle is off for an extended period of time, perhaps over a vacation etc., the PCS/Cellular modem 102 can be dropped to a very low power state where it no longer maintains contact with the wireless network.

Additionally, in FIG. 1, subsystems can include a BlueTooth transceiver 115 that can be provided to interface with devices such as phones, headsets, music players, and telematics user interfaces. The apparatus can comprise one or more user inputs, such as emergency button 117 and non-emergency button 118. Emergency button 117 can be coupled to the processor 106. The emergency button 117 can be located in a vehicle cockpit and activated an occupant of the vehicle. Activation of the emergency button 117 can cause processor 106 to initiate a voice and data connection from the vehicle to a central monitoring station, also referred to as a remote call center. Data such as GPS location and occupant personal information can be transmitted to the call center. The voice connection permits two way voice communication between a vehicle occupant and a call center operator. The call center operator can have local emergency responders dispatched to the vehicle based on the data received. In another embodiment, the connections are made from the vehicle to an emergency responder center.

One or more non-emergency buttons 118 can be coupled to the processor 106. One or more non-emergency buttons 118 can be located in a vehicle cockpit and activated by an occupant of the vehicle. Activation of the one or more non-emergency buttons 118 can cause processor 106 to initiate a voice and data connection from the vehicle to a remote call center. Data such as GPS location and occupant personal information can be transmitted to the call center. The voice connection permits two way voice communications between a vehicle occupant and a call center operator. The call center operator can provide location based services to the vehicle occupant based on the data received and the vehicle occupant's desires. For example, a button can provide a vehicle occupant with a link to roadside assistance services such as towing, spare tire changing, refueling, and the like. In another embodiment, a button can provide a vehicle occupant with concierge-type services, such as local restaurants, their locations, and contact information; local service providers their locations, and contact information; travel related information such as flight and train schedules; and the like.

For any voice communication made through the VTU 101, text-to-speech algorithms can be used so as to convey predetermined messages in addition to or in place of a vehicle occupant speaking. This allows for communication when the vehicle occupant is unable or unwilling to communicate vocally.

In an aspect, apparatus 101 can be coupled to a telematics user interface located remote from the apparatus. For example, the telematics user interface can be located in the cockpit of a vehicle in view of vehicle occupants while the apparatus 101 is located under the dashboard, behind a kick panel, in the engine compartment, in the trunk, or generally out of sight of vehicle occupants.

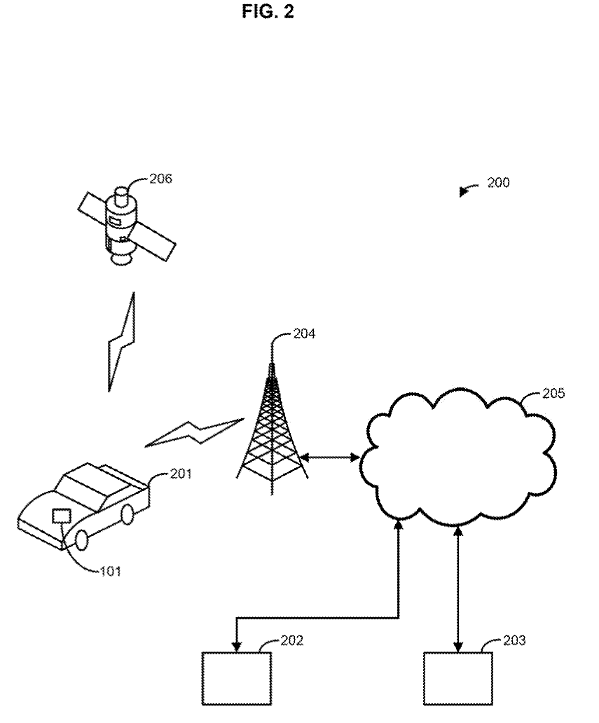

FIG. 2 is a block diagram illustrating an exemplary vehicle entertainment statistics system 200 showing network connectivity between various components. The vehicle entertainment statistics system 200 can comprise a VTU 101 located in a motor vehicle 201. The vehicle entertainment statistics system 200 can comprise a central station 202. The central station 202 can serves as a market specific data gatekeeper. That is, users 203 can pull information from specific, multiple or all markets at any given time for immediate analysis. The distributed computing model has no single point of complete system failure, thus minimizing vehicle entertainment statistics system 200 downtime. In an embodiment, central station 202 can communicate through an existing communications network (e.g., wireless towers 204 and communications network 205). Vehicle entertainment statistics system 200 can comprise at least one satellite 206 from which a satellite radio provider can transmits a signal. These signals can be received by a satellite radio in the vehicle 201.

The vehicle entertainment statistics system 200 can comprise a plurality of users 203 (radio providers, television providers, corporate advertisers, advertising agencies, and the like) which can access vehicle entertainment statistics system 200 using a personal computer (PC) or other such computing device, running a commercially available Web browser. For simplicity, FIG. 2 shows only one user 203. The users 203 can connect to the entertainment statistics system 200 via the communications network 205. In an embodiment, communications network 205 can comprise the Internet.

The vehicle entertainment statistics system 200 can comprise a central station 202 which can comprise one or more central station servers. In some aspects, one or more central station servers can serve as the “back-bone” (i.e., system processing) of the present vehicle entertainment statistics system 200. One skilled in the art will appreciate that vehicle entertainment statistics system 200 can utilize servers (and databases) physically located on one or more computers and at one or more locations. Central station server can comprise software code logic that is responsible for handling tasks such as data interpretations, statistics processing, data preparation and compression for output to VTU 101, and report generation for output to users 203. In an embodiment of the present vehicle entertainment statistics system 200, central station servers can have access to a repository database which can be a central store for all information and vehicle entertainment data within the vehicle entertainment statistics system 200 (e.g., executable code, subscriber information such as login names, passwords, etc., and vehicle and demographics related data). Central station servers can also provide a “front-end” for the vehicle entertainment statistics system 200. That is, a central station server can comprise a Web server for providing a Web site which sends out Web pages in response to requests from remote browsers (i.e., users 203). More specifically, a central station server can provide a graphical user interface (GUI) “front-end” to users 203 of the vehicle entertainment statistics system 200 in the form of Web pages. These Web pages, when sent to the user PC (or the like), can result in GUI screens being displayed.

As described above, VTU 101 can communicate with one or more computers, either through direct wireless communication and/or through a network such as the Internet. Such communication can facilitate data transfer, voice communication and the like. One skilled in the art will appreciate that what follows is a functional description of an exemplary operating environment and that functions can be performed by software, by hardware, or by any combination of software and hardware.

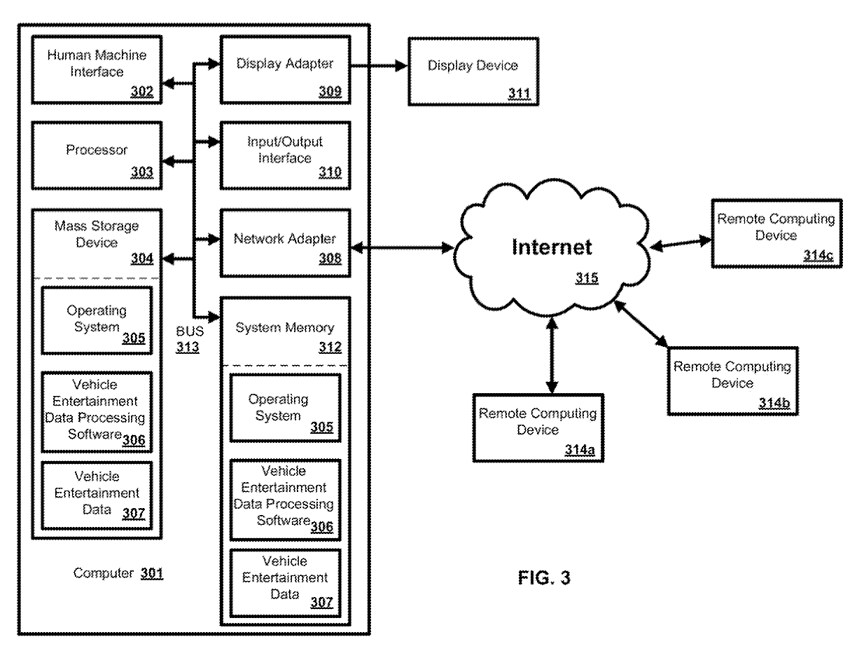

FIG. 3 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The methods and systems can be operational with numerous other general purpose or special purpose computing system environments or configurations. Examples of well known computing systems, environments, and/or configurations that can be suitable for use with the system and method comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

In another aspect, the methods and systems can be described in the general context of computer instructions, such as program modules, being executed by a computer. Generally, program modules comprise routines, programs, objects, components, data structures, etc. that perform particular tasks or implement particular abstract data types. The methods and systems can also be practiced in distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computer 301. The components of the computer 301 can comprise, but are not limited to, one or more processors or processing units 303, a system memory 312, and a system bus 313 that couples various system components including the processor 303 to the system memory 312.

The system bus 313 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI) bus, PCI-Express bus, Universal Serial Bus (USB), and the like. The bus 313, and all buses specified in this description can also be implemented over a wired or wireless network connection and each of the subsystems, including the processor 303, a mass storage device 304, an operating system 305, telematics software 306, vehicle entertainment data 307, a network adapter (or communications interface) 308, system memory 312, an Input/Output Interface 310, a display adapter 309, a display device 311, and a human machine interface 302, can be contained within one or more remote computing devices 314a,b,c at physically separate locations, connected through buses of this form, in effect implementing a fully distributed system. In one aspect, a remote computing device can be a VTU 101.

The computer 301 typically comprises a variety of computer readable media. Exemplary readable media can be any available media that is accessible by the computer 301 and comprises, for example and not meant to be limiting, both volatile and non-volatile media, removable and non-removable media. The system memory 312 comprises computer readable media in the form of volatile memory, such as random access memory (RAM), and/or non-volatile memory, such as read only memory (ROM). The system memory 312 typically contains data such as vehicle entertainment data 307 and/or program modules such as operating system 305 and vehicle entertainment data processing software 306 that are immediately accessible to and/or are presently operated on by the processing unit 303. Vehicle entertainment data 307 can comprise any data generated by, generated for, received from, or sent to the VTU.

In another aspect, the computer 301 can also comprise other removable/non-removable, volatile/non-volatile computer storage media. By way of example, FIG. 3 illustrates a mass storage device 304 which can provide non-volatile storage of computer code, computer readable instructions, data structures, program modules, and other data for the computer 301. For example and not meant to be limiting, a mass storage device 304 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 304, including by way of example, an operating system 305 and vehicle entertainment data processing software 306. Each of the operating system 305 and vehicle entertainment data processing software 306 (or some combination thereof) can comprise elements of the programming and the vehicle entertainment data processing software 306. Vehicle entertainment data 307 can also be stored on the mass storage device 304. Vehicle entertainment data 307 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

In another aspect, the user can enter commands and information into the computer 301 via an input device (not shown). Examples of such input devices comprise, but are not limited to, a keyboard, pointing device (e.g., a “mouse”), a microphone, a joystick, a scanner, tactile input devices such as gloves, and other body coverings, and the like These and other input devices can be connected to the processing unit 303 via a human machine interface 302 that is coupled to the system bus 313, but can be connected by other interface and bus strictures, such as a parallel port, game port, an IEEE 1394 Port (also known as a Firewire port), a serial port, or a universal serial bus (USB).

In yet another aspect, a display device 311 can also be connected to the system bus 313 via an interface, such as a display adapter 309. It is contemplated that the computer 301 can have more than one display adapter 309 and the computer 301 can have more than one display device 311. For example, a display device can be a monitor, an LCD (Liquid Crystal Display), or a projector. In addition to the display device 311, other output peripheral devices can comprise components such as speakers (not shown) and a printer (not shown) which can be connected to the computer 301 via Input/Output Interface 310.

The computer 301 can operate in a networked environment using logical connections to one or more remote computing devices 31a,b,c. By way of example, a remote computing device can be a personal computer, portable computer, a server, a router, a network computer, a VTU 101, a PDA, a cellular phone, a “smart” phone, a wireless communications enabled key fob, a peer device or other common network node, and so on. Logical connections between the computer 301 and a remote computing device 314a,b,c can be made via a local area network (LAN) and a general wide area network (WAN). Such network connections can be through a network adapter 308. A network adapter 308 can be implemented in both wired and wireless environments. Such networking environments are conventional and commonplace in offices, enterprise-wide computer networks, intranets, and the Internet 315. In one aspect, the remote computing device 314a,b,c can be one or more VTU 101's.

For purposes of illustration, application programs and other executable program components such as the operating system 305 are illustrated herein as discrete blocks, although it is recognized that such programs and components reside at various times in different storage components of the computing device 301, and are executed by the data processor(s) of the computer. An implementation of vehicle entertainment data processing software 306 can be stored on or transmitted across some form of computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any method or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The processing of the disclosed methods and systems can be performed by software components. The disclosed system and method can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

In an embodiment of the present vehicle entertainment statistics system 200, the central station 202 can comprise a paging network that communicates wirelessly with the VTU 101. The central station 202 can also comprise a central station server that can communicate with the paging network via email or other known communications process known to those skilled in the art. The central station 202 can compile vehicle entertainment data retrieved from the VTU 101. This compiled data is then accessed by users 203 through the communications network 205, for example, the Internet. In some aspects, vehicle entertainment data can comprise the present radio station setting, station preset information, time stamp and date stamp of radio station selection, global positioning system coordinates, and radio status.

In an embodiment of the present vehicle entertainment statistics system 200, VTU 101 can comprise a transceiver that uses existing wireless communication networks to transfer information collected by the VTU 101 and stored in memory to central station 202.

Components that comprise central station 202 can be connected and communicate via a wide or local area network (WAN or LAN) running a secure communications protocol (e.g., secure sockets layer (SSL)) and having a connection to the communications network 205.

In one aspect, an exemplary flow and operation of the vehicle entertainment statistics system 200 can be as follows: After a pre-determined time interval (e.g., a time interval measured in days, hours, minutes, etc.) of monitoring the entertainment choices of a vehicle occupant, the VTU 101 prepares stored vehicle entertainment information data for transmission as one or more packets. A packet can be sent via a wireless link to central station 202 through communications network 205. There, the vehicle entertainment data can be processed (i.e., compiled and analyzed) by a server. The processed entertainment data can then be made ready for distribution (i.e., reports generated by server) to users 203. The VTU 201 may be configured to transmit vehicle entertainment data collected from the vehicle with varying frequency (e.g., once every 5 minutes, twice a day, etc.). Such frequency can depend on factors such as the size of the memory of the VTU 101, bandwidth of the communications network 205, needs of the users 203, and the like.

In an aspect, the VTU 101 can transmit vehicle entertainment data upon a triggering event such as, but not limited to, transition from one vehicle entertainment system to another, tuning of a radio off of or on to a certain channel or preset, tuning of a video entertainment system oil to or off of a certain channel or preset.

VTU transmission of entertainment data packets can be on any of a fixed time basis, fixed amount of data basis, or fixed event basis and is downloadable from a central server and/or website.

In some aspects, vehicle entertainment data collected at the central server can optionally include personal information regarding the vehicle such as the Vehicle Identification Number (VIN). If personal information is collected the entertainment data can also be used, for example, to suggest, recommend, direct market, sell, forecast, etc. alternative entertainment content directly to the vehicle owner.

Vehicle entertainment data collected at the central server can optionally not include any personal information.

In an aspect, vehicle entertainment data can be used to derive ratings information, for example used by the marketing and advertising industries to determine rates.

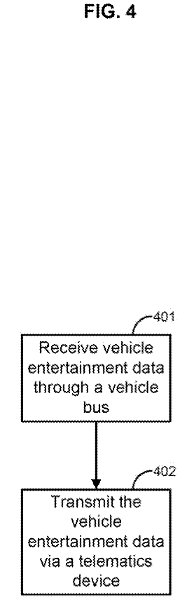

In an aspect, illustrated in FIG. 4, provided are methods for obtaining vehicle entertainment statistics, comprising receiving vehicle entertainment data through a vehicle bus at 401 and transmitting the vehicle entertainment data via a telematics device at 402.

The vehicle entertainment data can comprise one or more of, length of time an entertainment selection was experienced, volume and/or channel change correlated with entertainment selections, channel change correlated with time of day, channel change correlated with global positioning system coordinates, or channel changes correlated with content of a vehicle entertainment data stream. The vehicle entertainment data can comprise personal identification data. The personal identification data can comprise a Vehicle Identification Number (VIN).

The transmitted vehicle entertainment data can be received and processed at a central station, such as a telematics service provider telematics operations center (“TOC”) server. The transmitted vehicle entertainment data can be processed to suggest and/or direct market alternative entertainment content directly to a vehicle owner. The transmitted vehicle entertainment data can be processed to derive ratings information.

The methods can further comprise, receiving a suggestion for alternative entertainment content based on the vehicle entertainment data. The methods can further comprise, receiving an advertisement for a good or service based on the vehicle entertainment data.

Transmission of the vehicle entertainment data can be initiated based on a triggering event. The triggering event can comprise one or more of, transition from one vehicle entertainment system to another, tuning of a radio off of or on to a certain channel or preset, tuning of a video entertainment system on to or off of a certain channel or preset. Transmission of the vehicle entertainment data can be initiated on one or more of, a fixed time basis, fixed amount of data basis, or fixed event basis.

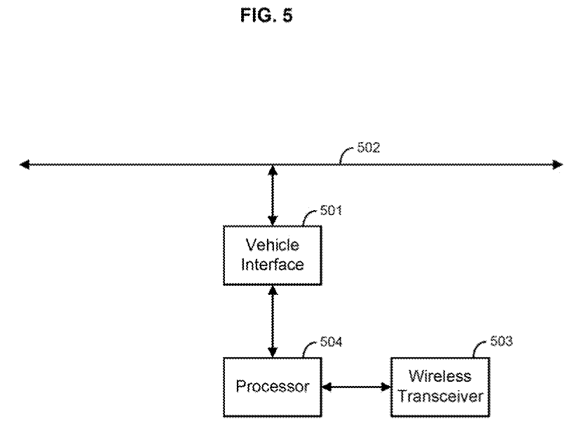

In another aspect, illustrated in FIG. 5, provided is an apparatus for obtaining vehicle entertainment statistics, comprising a vehicle interface 501, coupled to a vehicle bus 502, wherein the vehicle interface 501 is configured to receive vehicle entertainment data through the vehicle bus 502, a wireless transceiver 503, configured for transmitting the vehicle entertainment data, and a processor 504, coupled to the vehicle interface 501 and the wireless transceiver 503, wherein the processor 504 is configured for receiving the vehicle entertainment data from the vehicle interface 501 and for providing the vehicle entertainment data to the wireless transceiver 503. The apparatus can further comprise a GPS transceiver coupled to the processor 504.

The vehicle entertainment data can comprise one or more of, length of time an entertainment selection was experienced, volume and/or channel change correlated with entertainment selections, channel change con-elated with time of day, channel change correlated with global positioning system coordinates, or channel changes correlated with content of a vehicle entertainment data stream. The vehicle entertainment data can comprise personal identification data. The personal identification data can comprise a Vehicle Identification Number (VIN). The transmitted vehicle entertainment data can be received and processed at a central station.

The transmitted vehicle entertainment data can be processed to suggest and/or direct market alternative entertainment content directly to a vehicle owner. The transmitted vehicle entertainment data can be processed to derive ratings information. The apparatus can be configured to receive a suggestion for alternative entertainment content based on the vehicle entertainment data. The apparatus can be configured to receive an advertisement for a good or service based on the vehicle entertainment data.

The wireless transceiver 503 can be configured to transmit the vehicle entertainment data based on a triggering event. The triggering event can comprise one or more of, transition from one vehicle entertainment system to another, tuning of a radio off of or on to a certain channel or preset, tuning of a video entertainment system on to or off of a certain channel or preset. The wireless transceiver 503 can be configured to transmit the vehicle entertainment data based on one or more of, a fixed time basis, fixed amount of data basis, or fixed event basis.

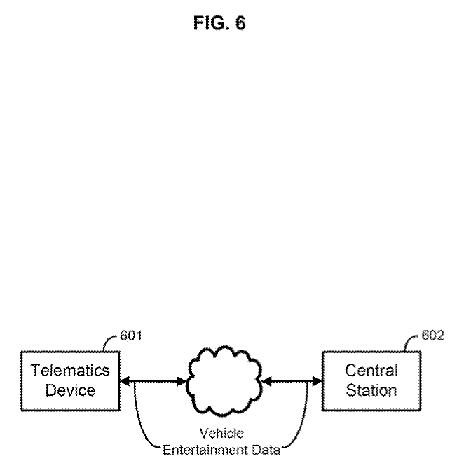

In another aspect, illustrated in FIG. 6, provided is a system for obtaining vehicle entertainment statistics, comprising a telematics device 601, configured for receiving vehicle entertainment data through a vehicle bus and transmitting the vehicle entertainment data and a central station 602, configured for receiving and processing the vehicle entertainment data.

The vehicle entertainment data can comprise one or more of, length of time an entertainment selection was experienced, volume and/or channel change correlated with entertainment selections, channel change correlated with time of day, channel change correlated with global positioning system coordinates, or channel changes correlated with content of a vehicle entertainment data stream. The vehicle entertainment data can comprise personal identification data. The personal identification data can comprise a Vehicle Identification Number (VIN). The transmitted vehicle entertainment data can be processed to suggest and/or direct market alternative entertainment content directly to a vehicle owner. The transmitted vehicle entertainment data can be processed to derive ratings information.

The central station can be configured to transmit a suggestion for alternative entertainment content based on the vehicle entertainment data to the telematics device. The central station can be configured to transmit an advertisement for a good or service based on the vehicle entertainment data to the telematics device.

The telematics device can be configured to transmit the vehicle entertainment data based on a triggering event. The triggering event can comprise one or more of, transition from one vehicle entertainment system to another, tuning of a radio off of or on to a certain channel or preset, tuning of a video entertainment system on to or off of a certain channel or preset. The telematics device can be configured to transmit the vehicle entertainment data based on one or more of, a fixed time basis, fixed amount of data basis, or fixed event basis.

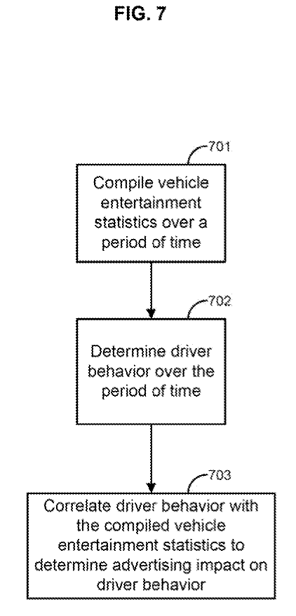

In another aspect, illustrated in FIG. 7, provide are methods for advertisement efficacy, comprising compiling vehicle entertainment statistics over a period of time at 701, determining driver behavior over the period of time at 702, and correlating driver behavior with the compiled vehicle entertainment statistics to determine advertising impact on driver behavior at 703. The period of time can comprise, for example, one month, two months, three months, six months, twelve months, eighteen months, twenty-four months, and the like.

Compiling vehicle entertainment statistics over a period of time can comprise receiving vehicle entertainment data from a telematics device, wherein the vehicle entertainment data was obtained through a vehicle bus. The vehicle entertainment data can comprise one or more of, length of time an entertainment selection was experienced, volume and/or channel change correlated with entertainment selections, channel change correlated with time of day, channel change correlated with global positioning system coordinates, or channel changes correlated with content of a vehicle entertainment data stream.

Receiving the vehicle entertainment data can be initiated based on a triggering event. The triggering event can comprise one or more of, transition from one vehicle entertainment system to another, tuning of a radio off of or on to a certain channel or preset, tuning of a video entertainment system on to or off of a certain channel or preset.

Determining driver behavior over the period of time can comprise receiving vehicle location data from a telematics device. Determining driver behavior over the period of time further can comprise correlating point of interest data with the received vehicle location data.

Correlating driver behavior with the compiled vehicle entertainment statistics to determine advertising impact on driver behavior can comprise determining an advertisement experienced by a vehicle operator, wherein the advertisement is associated with a first establishment at a first location, and determining a frequency that the vehicle was at the first location during the period of time. The methods can further comprise determining a frequency that the vehicle was at a second location during the period of time, wherein a second establishment is located at the second location and the second establishment competes with the first establishment.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method for configuring a vehicle device coupled to a vehicle bus in a vehicle for providing entertainment information corresponding to the vehicle, comprising:
monitoring operational signals on a vehicle bus, the signals corresponding to parameters of one, or more, entertainment devices coupled to a vehicle bus over a period, wherein the operational parameters include: volume, tone, broadcast station frequency, or identifier, artist and title of an entertainment program played from a storage medium, such as a compact disc, or DVD, status of an in-use indicator of a voice communication device, status of an in-use indicator of a data access device, such as a browser;
storing information corresponding to the parameters monitored during the period to a memory in the device coupled to the vehicle bus; and
transmitting the information stored in the memory corresponding to the predetermined period in a message that also comprises an identifier of the vehicle, to a central computer server over a wireless communication network.

2. A method for obtaining vehicle entertainment statistics, comprising:
receiving vehicle entertainment data through a vehicle bus; and
transmitting the vehicle entertainment data via a telematics device.

3. The method of claim 2, wherein the vehicle entertainment data comprises one or more of, length of time an entertainment selection was experienced, volume and/or channel change correlated with entertainment selections, channel change correlated with time of day, channel change correlated with global positioning system coordinates, or channel changes correlated with content of a vehicle entertainment data stream.

4. The method of claim 2, wherein transmitting the vehicle entertainment data is initiated based on a triggering event.

5. The method of claim 4, wherein the triggering event comprises one or more of, transition from one vehicle entertainment system to another, tuning of a radio off of or on to a certain channel or preset, tuning of a video entertainment system on to or off of a certain channel or preset.

6. The method of claim 2, wherein transmitting the vehicle entertainment data is initiated on one or more of, a fixed time basis, fixed amount of data basis, or fixed event basis.

7. The method of claim 2, wherein the vehicle entertainment data comprises personal identification data.

8. The method of claim 7, wherein the personal identification data comprises a Vehicle Identification Number (VIN).

9. The method of claim 2, wherein the transmitted vehicle entertainment data is received and processed at a central station.

10. The method of claim 9, wherein the transmitted vehicle entertainment data is processed to suggest and/or direct market alternative entertainment content directly to a vehicle owner.

11. The method of claim 9, wherein the transmitted vehicle entertainment data is processed to derive ratings information.

12. The method of claim 2, further comprising, receiving a suggestion for alternative entertainment content based on the vehicle entertainment data.

13. The method of claim 2, further comprising, receiving an advertisement for a good or service based on the vehicle entertainment data.

14. An apparatus for obtaining vehicle entertainment statistics, comprising:
a vehicle interface, coupled to a vehicle bus, wherein the vehicle interface is configured to receive vehicle entertainment data through the vehicle bus;
a wireless transceiver, configured for transmitting the vehicle entertainment data; and
a processor, coupled to the vehicle interface and the wireless transceiver, wherein the processor is configured for receiving the vehicle entertainment data from the vehicle interface and for providing the vehicle entertainment data to the wireless transceiver.

15. The apparatus of claim 14, wherein the vehicle entertainment data comprises one or more of, length of time an entertainment selection was experienced, volume and/or channel change correlated with entertainment selections, channel change con-elated with time of day, channel change correlated with global positioning system coordinates, or channel changes correlated with content of a vehicle entertainment data stream.

16. The apparatus of claim 14, wherein the wireless transceiver is configured to transmit the vehicle entertainment data based on a triggering event.

17. The apparatus of claim 16, wherein the triggering event comprises one or more of, transition from one vehicle entertainment system to another, tuning of a radio off of or on to a certain channel or preset, tuning of a video entertainment system on to or off of a certain channel or preset.

18. The apparatus of claim 14, wherein the wireless transceiver is configured to transmit the vehicle entertainment data based on one or more of, a fixed time basis, fixed amount of data basis, or fixed event basis.

19. The apparatus of claim 14, wherein the vehicle entertainment data comprises personal identification data.

20. The apparatus of claim 19, wherein the personal identification data comprises a Vehicle Identification Number (VIN).

21. The apparatus of claim 14, wherein the transmitted vehicle entertainment data is received and processed at a central station.

22. The apparatus of claim 21, wherein the transmitted vehicle entertainment data is processed to suggest and/or direct market alternative entertainment content directly to a vehicle owner.

23. The apparatus of claim 21, wherein the transmitted vehicle entertainment data is processed to derive ratings information.

24. The apparatus of claim 14, further comprising a GPS transceiver coupled to the processor.

25. A method for advertisement efficacy, comprising:
compiling vehicle entertainment statistics received from a vehicle during a period;
determining driver behavior during the period based on equipment operation signals received from the bus during the period;
correlating driver behavior with the compiled vehicle entertainment statistics to generate a driver behavior profile; and
determining advertising impact on driver behavior based on the driver behavior profile.

26. The method of claim 25, wherein compiling vehicle entertainment statistics over a period of time comprises:
receiving vehicle entertainment data from a telematics device, wherein the vehicle entertainment data was obtained through the vehicle bus.

27. The method of claim 26, wherein the vehicle entertainment data comprises one or more of, length of time an entertainment selection was experienced, volume and/or channel change correlated with entertainment selections, channel change correlated with time of day, channel change correlated with global positioning system coordinates, or channel changes correlated with content of a vehicle entertainment data stream.

28. The method of claim 26, wherein receiving the vehicle entertainment data is initiated based on a triggering event.

29. The method of claim 28, wherein the triggering event comprises one or more of, transition from one vehicle entertainment system to another, tuning of a radio off of or on to a certain channel or preset, tuning of a video entertainment system on to or off of a certain channel or preset.

30. The method of claim 25, wherein determining driver behavior over the period of time comprises receiving vehicle location data from a telematics device.

31. The method of claim 30, determining driver behavior over the period of time further comprises correlating point of interest data with the received vehicle location data.

32. The method of claim 25, wherein correlating driver behavior with the compiled vehicle entertainment statistics to determine advertising impact on driver behavior comprises:
determining an advertisement experienced by a vehicle operator, wherein the advertisement is associated with a first establishment at a first location; and
determining a frequency that the vehicle was at the first location during the period of time.

33. The method of claim 32, further comprising:
determining a frequency that the vehicle was at a second location during the period of time, wherein a second establishment is located at the second location and the second establishment competes with the first establishment.
